(19) United States
(12) Patent Application Publication
(10) Pub. No.: US 2008/0294355 A1
(43) Pub. Date: Nov. 27, 2008

(54) Tire Lateral Force Determination in Electrical Steering Systems

(76) Inventors: Thomas Berthold, Darmstadt (DE); Ralf Schwarz, Ingolstadt (DE); Stefan Fritz, Erzhausen (DE)

Correspondence Address: CONTINENTAL TEVES, INC., ONE CONTINENTAL DRIVE, AUBURN HILLLS, MI, 48326-1581, US

(21) Appl. No.: 10/593,730

(22) PCT Filed: Mar. 23, 2005
(86) PCT No.: PCT/EP05/51338

§ 371 Date: Aug. 14, 2008

(30) Foreign Application Priority Data
Mar. 23, 2004 (DE) 10 2004 014 177.0

(51) Int. Cl. G01L 3/00

(52) U.S. Cl. 702/41

(57) ABSTRACT

A method for calculation of the lateral force in a motor vehicle with an electromechanical or electrohydraulic steering system is disclosed. The method comprises the following steps: firstly a steering column force is recorded, from which a total restoring torque is calculated. The total restoring torque comprises restoring torques generated by differing forces acting on the wheels. Said restoring torques include a restoring torque generated by lateral force and other restoring torques. The other restoring torques are quantitatively determined on the basis of measured values and subtracted from the total restoring torque, in order to determine the restoring torque generated by lateral force. Finally the lateral force is determined from the restoring torque generated by the lateral force.

This application is the U.S. National Phase Application of PCT International application No. PCT/EP2005/051338, filed Mar. 23, 2005, which claims priority to German Patent Application No. DE 10 2004 177.0 filed on Mar. 23, 2004.

### BACKGROUND OF THE INVENTION

1. Technical Field

The present invention relates to a method for determining the tire lateral force in a motor vehicle with an electromechanical or electrohydraulic steering system.

2. Description of the Related Art

In addition to very customary ABS brake systems, many up-to-date motor vehicles are equipped at an increasing rate with driving dynamics control systems in order to enhance the active safety of vehicles. Driving dynamics control systems are employed to check and limit yaw movements of the vehicle about its vertical axis. Sensors detect variables predetermined by the driver such as the steering angle, the accelerator pedal position, and the brake pressure, for example. In addition, the lateral acceleration and the rotational behavior of the individual vehicle wheels are measured. The efficiency of driving dynamics control systems could be increased still further by gathering further variables, which influence the dynamic performance of the motor vehicle. For example, among these variables is the coefficient of friction of the vehicle wheels on the roadway or the sideslip angle, which indicates the angular deviation of the speed vector from the vehicle's center line.

### SUMMARY OF THE INVENTION

The invention discloses a method, by which at least one additional variable can be determined, which influences the dynamic performance of a vehicle.

This is achieved by calculating the lateral force in a motor vehicle equipped with an electromechanical or electrohydraulic steering system. The method comprises the following steps:
recording a steering rod force;
calculating a total restoring torque from the steering rod force, with the said restoring torque comprising a restoring torque generated by lateral force and other restoring torques;
quantitative determination of the other restoring torques based on measured values;
subtracting the other restoring torques from the total restoring torque for determining the restoring torque generated by the lateral force; and
determining the lateral force from the restoring torque generated by the lateral force.

The lateral force at the wheels is a favorable input variable for many driving dynamics control systems. The lateral force can be used to determine the coefficient of friction or to estimate the sideslip angle, for example.

Modern electromechanically or electrohydraulically assisted steering systems or electromechanical or electrohydraulic steering systems, which are mechanically uncoupled from the driver, due to their principle comprise force or torque sensors, from which the steering rod force (toothed rack in rack-and-pinion steering) or steering tie rod forces are measured or calculated. The tire lateral forces can be determined from the above-mentioned forces. The method of the invention makes use of this sensor equipment in order to define the tire lateral forces.

In an improvement of the invention, a transmission ratio between the steering rod force and the total restoring torque is included in the determination of the lateral force.

Suitably, the transmission ratio can be responsive to the steering angle. Favorably, a kingpin inclination and/or a caster angle are included in the determination of the lateral force.

The other restoring torques that are important for the invention can comprise restoring torques generated by rolling resistance, brake force, driving power, and/or by vertical force.

In different embodiments of the method of the invention, the steering rod force can be detected as a force acting on the left and right steering tie rod or as the total steering rod force.

Advantageously, the total steering rod force is calculated from a steering torque generated by the driver, steering amplification, and a steering ratio. It can be provided that a steering-angle-responsive steering ratio enters into the calculation of the steering rod force.

In an embodiment of the invention, the total steering rod force is determined from the motor current and/or the motor position of one or more electric motors of the electromechanical or electrohydraulic steering system.

Thus, the method of the invention can be extended suitably in such a fashion that a sideslip angle and/or a coefficient of friction are determined from the determined lateral force.

### BRIEF DESCRIPTION OF THE DRAWINGS

The drawings schematically illustrate an electromechanical steering system in which a method according to the invention can be implemented. In the drawings:

FIG. 1 is a schematic view of an electromechanical steering system;

FIG. 2 shows the caster angle and kingpin inclination at a vehicle wheel;

FIG. 3 shows the lateral force lever arm at a vehicle wheel;

FIG. 4 shows the brake force lever arm at a vehicle wheel;

FIG. 5 shows the disturbing force lever arm at a vehicle wheel;

FIG. 6 shows the vertical force lever arm at a vehicle wheel and its relation to the kingpin inclination; and

FIG. 7 shows the vertical force lever arm at a vehicle wheel and its relation to the caster angle.

### DETAILED DESCRIPTION OF THE PREFERRED EMBODIMENTS

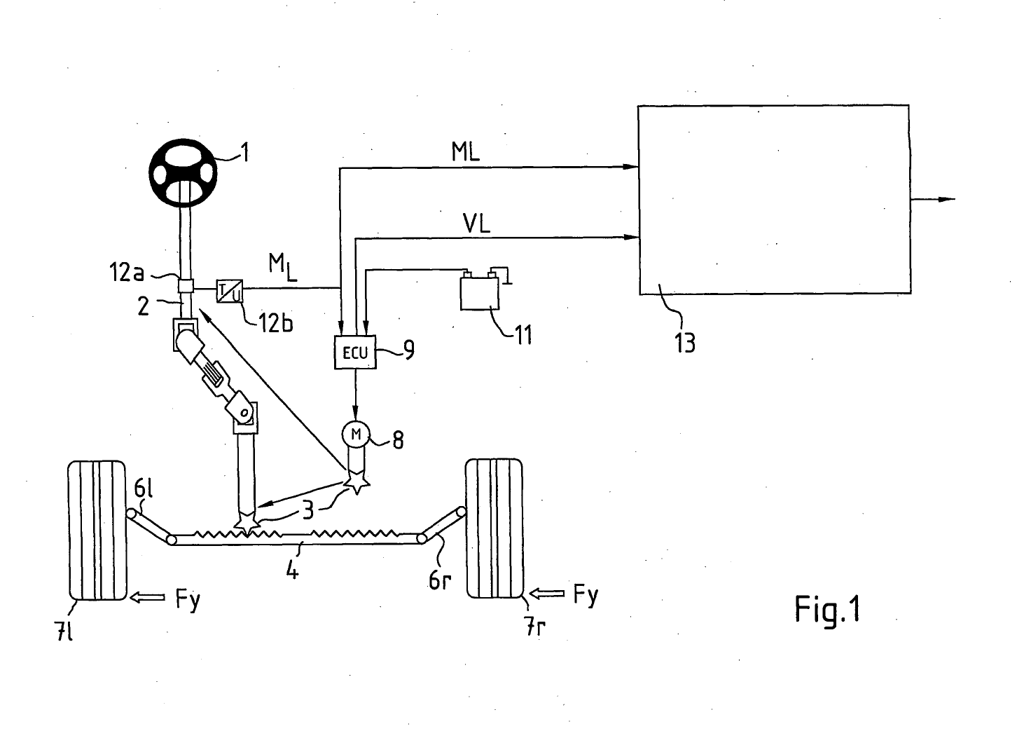

FIG. 1 illustrates the front axle of a motor vehicle and the steering system. A driver directs the vehicle by turning a steering wheel 1 into a desired driving direction. The steering movement of the steering wheel 1 is transferred mechanically to a pinion 3 by way of a steering column 2. Pinion 3 engages a spur rack 4. Rotation of the steering wheel 1 will thus cause the spur rack 4 to move to and fro. The spur rack 4 is connected at either end to respectively one left and one right steering tie rod 6l, 6r, which transmit the movement of the spur rack 4 to front wheels 7l and 7r, respectively, of the vehicle. The suspension of the vehicle front wheels 7l, 7r has been omitted in FIG. 1 for the sake of clarity. The so far described steering system is purely mechanical and necessitates great steering forces from the driver at high weights of the vehicle. For this reason, the steering column 2 is additionally coupled to an electric motor 8 in terms of driving, which assists the steering movements of the driver at the steering wheel 1. Although motor 1 is shown in FIG. 1 adjacent to the steering column 2, it drives the steering column 2 in reality and acts on the pinion 3. Motor 8 is controlled by a motor control 9 and is fed with energy from battery 11. In addition, the steering column 2 is equipped with a torque sensor 12a and a transducer 12b, which detects the magnitude of the steering torque M_{L} generated by the driver and sends it to the motor control 9 and to a lateral force calculation unit 13. Further, the motor control unit 9 sends a signal V_{L} to the lateral force calculation unit 13. The signal V_{L} describes the amplification of the steering torque M_{L} generated by the driver. The lateral force calculation unit 13 outputs an output signal representative of the lateral force F_{y} that acts on the front wheels 7l, 7r.

The mode of operation of the steering system and the method of calculating the lateral force F_{y} are described below.

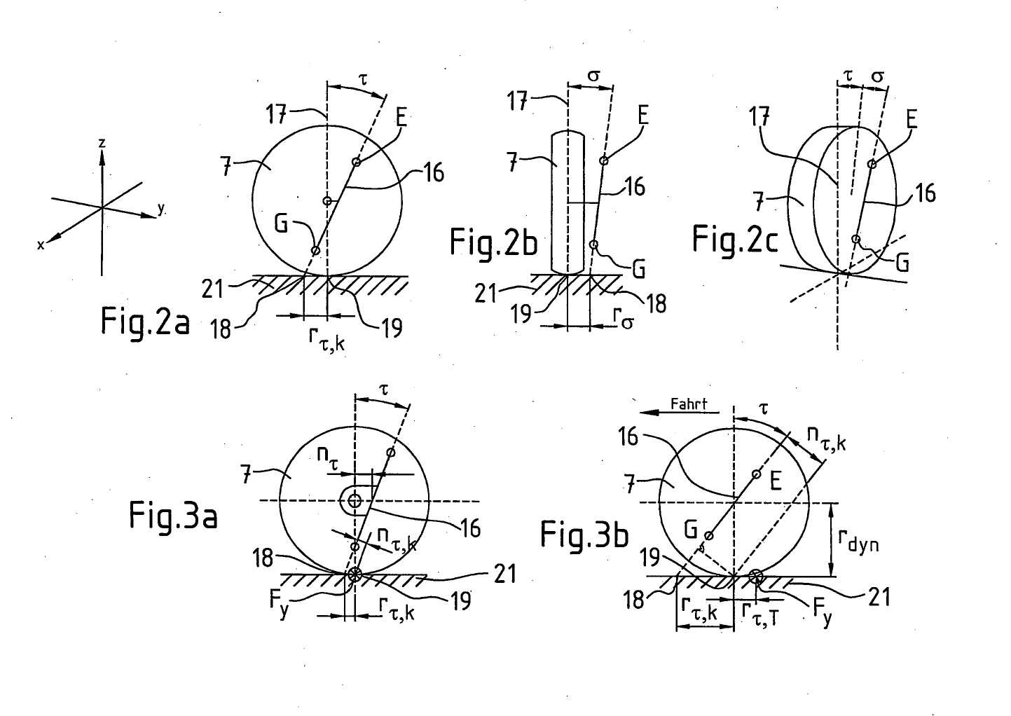

Characteristic values of the front-wheel suspension have been explained graphically in FIGS. 2a to 2c for better comprehension of the invention. For the sake of clarity, the characteristic values are illustrated only by way of example of the right front wheel of a vehicle, which is designated by reference numeral 7. Steering movements cause the wheels to swivel about each one axis of rotation formed fast with the vehicle that is referred to as steering axis 16. The steering axis 16 firmly connects to the vehicle body at two points E and G. The position of the steering axis 16 relative to a system of coordinates X, Y, Z firmly connected to the vehicle body is described by the following characteristic values.

FIG. 2a shows a side view of the wheel 7. The angle between the steering axis 16 and the normal line of the road 17 in the longitudinal plane of the vehicle is referred to as caster angle τ. The distance between the point 18 where the steering axis 16 intersects the roadway 21 and an ideal tire contact point 19 in the vehicle longitudinal plane is referred to as caster offset r_{τ,k}.

FIG. 2b shows a front view of the wheel 7. The angle between the steering axis 16 and the road normal line 17 in the vehicle transversal plane is referred to as kingpin inclination σ. The distance between the intersection point 18 of the steering axis 16 through the roadway 21 and the ideal tire contact point 19 in the vehicle transversal plane are referred to as roll radius rσ.

Further, FIG. 2c shows an inclined front view of the wheel 7 in which both the caster angle τ and the kingpin inclination σ are shown.

In electromechanically or electrohydraulically assisted steering systems, the steering torque M_{L} generated by the driver is measured in order to calculate and adjust the rate of amplification V_{L} to be provided by the electric motor. Based on the usually steering-angle responsive transmission ratio i_{Ll} (δ) between the steering wheel moment and the summed steering rod force F_{L,sum} as well as the steering amplification V_{L}, the summed steering rod force is calculated as follows:

F_{L,sum}=M_{L}·V_{L}·i_{L1}(δ) (1).

The summed steering rod force F_{L,sum} results from the addition of the forces F_{Lr} and F_{Ll} that act from the right and the left steering tie rod vertically on the steering rod.

In electromechanical or electrohydraulic steering operations, which are uncoupled mechanically from the driver, either both steering tie rod forces are measured separately (F_{L,r} and F_{L,l}) or the summed steering tie rod force F_{L,sum} is measured or estimated based on the motor current and/or the motor position of the electric motor(s). These forces are e.g. required for the generation of the haptic steering feeling.

The procedure for calculating the single steering rod forces F_{Lr} and F_{Ll} is identical, except for the parameters and the directions of force transferred and is therefore performed using the example of a wheel 7 without wheel indices. The steering rod force F_{L} compensates restoring torques, which act on the wheel 7 and are generated by different forces. The sum of the restoring torques is referred to by M_{z} because the total restoring torque acts about the z-axis of the system of coordinates illustrated in FIG. 2.

A second, likewise steering-angle-responsive transmission ratio i_{L2} (δ) acts between the steering rod force F_{L} the total restoring torque M, about the steering axis 16:

M_{z}=F_{L}·i_{L2}(δ) (2).

A restoring torque generated by a lateral force F_{y} is also comprised in the total restoring torque. The relation between the lateral force F_{y} and the restoring torque generated by it will be explained in the following.

FIG. 3a again shows a side view of the vehicle wheel 7. A lateral force F_{y} acts upon the wheel 7 at the tire contact point. As the steering axis 16 is tilted in relation to the vertical line by the caster angle τ, the lateral force F_{y} is applied relative to the steering axis 16 in an offset manner. The distance between the point of application of the lateral force F_{y}, which corresponds to the tire contact point, and the steering axis 16 is referred to as kinematic lateral force lever arm n_{τk}. The lateral force F_{y}, which is applied to the lateral force lever arm n_{τk}, generates a restoring torque M_{z,y} according to:

M_{z,y}=F_{y}·n_{τ,k} (3).

This consideration applies only to the case without movement of the vehicle and without oblique motion of wheel 7.

Oblique motion causes the point of application of the lateral force F_{y} to displace by the wheel caster behind the middle of the wheel, with the result that the lateral force lever arm is extended. The lateral force lever arm extends in addition to the kinematic lateral force lever arm n_{τk} by the component of the wheel caster r_{τ,T} that is normal to the steering axis so that the following applies to the total lateral force lever r_{σ,t}:

r_{σ,t}=n_{τ,k}+r_{τ,T}·cos τ (4).

The desired lateral force F_{y} enters into the restoring torque M_{z} by way of the lateral force lever arm r_{σ,t} and the kinematic kingpin inclination σ. The restoring torque generated by the lateral force F_{y} is designated by M_{z,y}

M_{z,Y}=F_{y}·cos σ·r_{σ,t} (5).

The result of inserting the equation (4) into equation (5) is for the restoring torque M_{z,y}:

M_{z,y}=F_{y}·cos σ·(n_{τ,k}+r_{τ,T}·cos τ) (6).

In addition to the lateral force F_{y}, further forces act on the steering axis in a torque-generating fashion. In order to separate these torques from the torque M_{z,y} generated by the lateral force, the individual calculation formulas are indicated in the following.

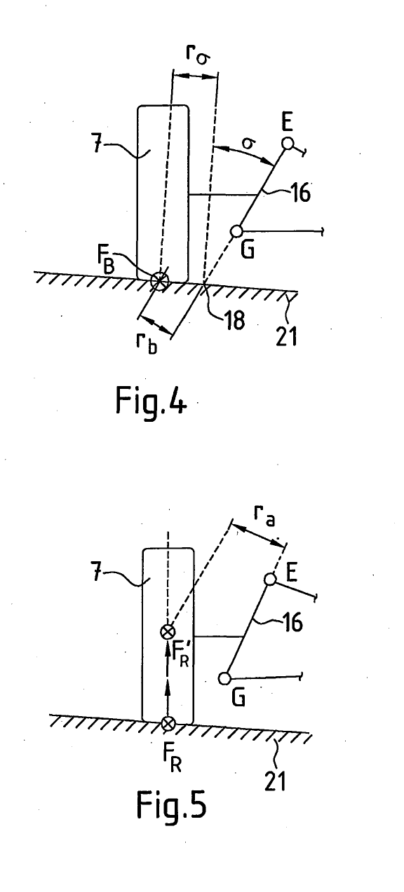

Among the other forces, which act on the steering axis 16 in a torque-generating fashion, is a brake force F_{B}, which is transmitted from a roadway 21 to a wheel 7. FIG. 4 shows a front view of the vehicle front wheel 7. The brake force F_{B} that is transmitted from the roadway 27 onto wheel 7 is applied at a distance r_{σ} from the intersection point 18 of the steering axis 16 through the roadway 21. The length of the brake lever arm r_{b} that is normal to the steering axis 16 amounts to:

r_{b}=r_{σ}·cos σ (7),

and σ indicates the kingpin inclination. In consideration of the caster angle τ, the torque about the steering axis 16 that is generated by the brake force F_{B} is achieved by:

M_{z,B}=F_{B}·cos τ·r_{b} (8).

Thus, the restoring torque Mz,B generated by the brake force is obtained by:

M_{z,B}=F_{B}·cos τ·r_{σ}·cos σ (9)

This calculation applies only to vehicles with an outboard brake. For vehicles with an inboard brake, a disturbing force lever arm rₐ that will be introduced in the following paragraph must be used instead of the brake force lever arm r_{b}.

As FIG. 5 shows, the rolling resistance force and driving power, in contrast to the brake force, does not act via the brake force lever arm r_{b}, but acts by way of the above mentioned disturbing force lever arm on the steering axis 16 in a torque-generating fashion. The different working levers develop because only a force rather than a moment is transmitted between wheel and wheel carrier for driving power and rolling resistance force F_{R}·F_{R′}=F_{R} in the event of intersection in the middle of the wheel (see FIG. 5). Thus, there results for the restoring torque M_{Z,R} generated due to the rolling resistance force F_{R}:

M_{Z,R}=F_{R}·cos τ·rₐ (10).

Herein, rₐ represents the disturbing force lever arm being normal to the steering axis 16, and cos τ takes into account the distribution of forces on account of the caster angle τ. The rolling resistance force F_{R} can be obtained from the vertical force F_{Z} and the coefficient of the rolling resistance.

A driving power F_{A} produces likewise by way of the disturbing force lever arm rₐ a torque M_{A} about the steering axis 16 according to:

M_{Z,A}=F_{A}·cos τ·rₐ (11).

Further, a vertical force F_{z} generates a restoring torque, which is significant especially at lower speeds, when only minor lateral forces develop.

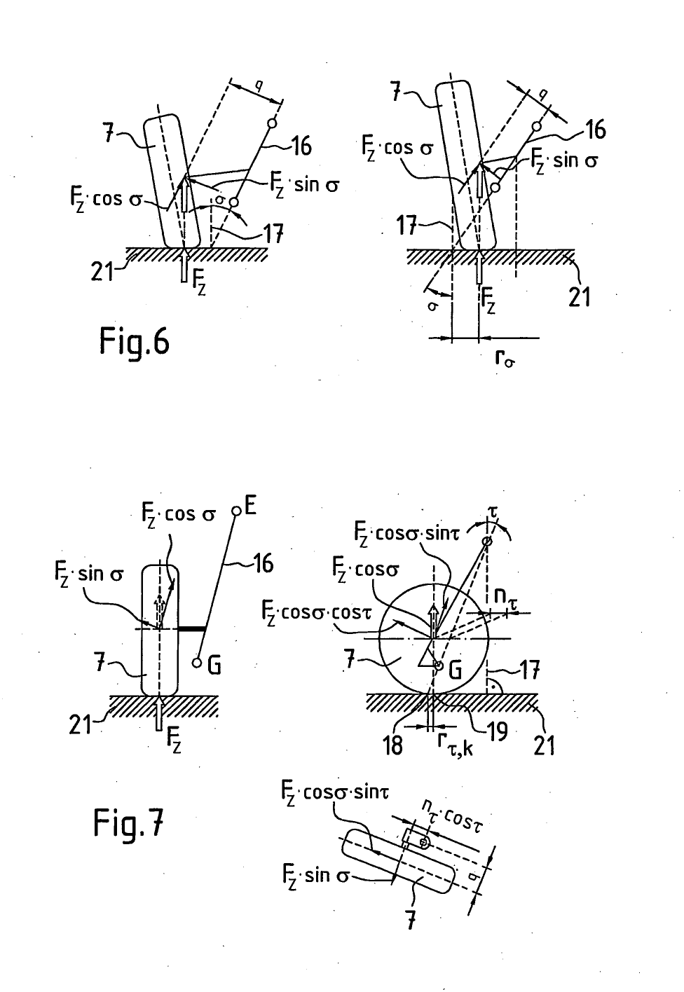

Due to the kingpin inclination σ, the vertical force F_{z} scaled with cos τ acts depending on the steering angle δ along with the vertical force lever arm q as a restoring torque as shown in FIG. 6:

M_{Z,Z1}=F_{z}·cos τ·sin σ·sin δ·q (12)

The vertical force lever arm or steering lever arm q is calculated from the tire radius r_{dyn}, the roll radius rσ (FIGS. 2b and 4) and the kingpin inclination σ as follows:

q=(r_{σ}+r_{dyn}·tan σ)·cos σ (13)

The restoring torque is calculated with the vertical force lever arm as follows:

M_{Z,Z1}=F_{z}·cos τ·sin σ·sin δ·(rσ+r_{dyn}·tan σ)·cos σ (14)

The geometric ratios described above are illustrated in FIG. 6.

In addition to the torque generated by the kingpin inclination, the vertical force F, produces another restoring torque M_{Z,Z2} due to the caster angle τ:

M_{Z,Z2}=F_{z}·sin σ·cos τ sin δ·n_{τ} (15),

wherein the caster offset n_{τ} indicates the distance between the point of application of the vertical force F_{z} and the point of attachment at the vehicle. The geometric ratios for this situation are illustrated in FIG. 7.

The desired lateral force F_{y} is calculated from the total restoring torque M_{z} determined by way of the steering rod force F_{L} as follows. It applies that the total restoring torque M_{z} is the sum of the individual restoring torques:

M_{z}=M_{z,y}+M_{Z,B}+M_{Z,R}+M_{Z,A}+M_{Z,Z1}+M_{Z,Z2} (16)

Equation (6) is applicable for the lateral force torque M_{z,y}. When inserting equation (6) into equation (16) and rearranging, the following results:

F_{y}=(M_{z}−M_{z,B}−M_{Z,R}−M_{Z,A}−M_{z,Z1}−M_{z,z2})/(cos σ·(n_{τ,k}+r_{τ,T}·cos τ)) (17).

It follows from this equation that the subsequent parameters must be determined in order to achieve the lateral force F_{y}:

σ: kingpin inclination
τ: caster angle
τδ: steering angle
r_{σ}: roll radius
n_{τ}: caster offset
r_{dyn}: tire radius
rₐ: disturbing force lever arm
n_{τ,k}: kinematic lateral force lever arm
r_{τ,T}: wheel caster

The following variables are measured using the sensors already provided for customary driving dynamics control operations in addition to the above-mentioned steering torque ML, the steering rod force F_{L}, the steering amplification VL and the transmission ratios i_{L1},i_{L2}:

F_{B}: brake force
F_{A}: driving power
F₂: vertical force

The total of parameters and measured quantities eventually permits determining the lateral force F_{y} according to equation (17), as has been described hereinabove.

The invention has been described based on the example of an electromechanical steering system, however, it lends itself to being implemented in a corresponding fashion in electrohydraulic steering systems as well.

1-11. (canceled)

12. Method for calculating the lateral force in a motor vehicle with an electromechanical or electrohydraulic steering system, the method comprising:
recording a steering rod force;
calculating a total restoring torque from the steering rod force, with the said restoring torque comprising a restoring torque generated by lateral force and other restoring torques;
quantitatively determining the other restoring torques based on measured values;
subtracting the other restoring torques from the total restoring torque for determining the restoring torque generated by the lateral force; and
determining the lateral force from the restoring torque generated by the lateral force.

13. Method in accordance with claim 12, wherein a transmission ratio between the steering rod force and the total restoring torque is included in the determination of the lateral force.

14. Method in accordance with claim 13, wherein the transmission ratio is responsive to a steering angle.

15. Method in accordance with claim 12, wherein a kingpin inclination, a caster angle or a combination thereof is included in the determination of the lateral force.

16. Method in accordance with claim 12, wherein the other restoring torques comprise one or more of a restoring torque generated by rolling resistance, a brake force, a driving power, and a vertical force.

17. Method in accordance with claim 12, wherein the steering rod force is detected as a force that acts the left and right steering tie rods or as a total steering rod force.

18. Method in accordance with claim 17, wherein the total steering rod force is calculated from a steering torque generated by the driver, a steering amplification, and a steering ratio.

19. Method in accordance with claim 18, wherein a steering-angle-responsive steering ratio enters into the calculation of the steering rod force.

20. Method in accordance with claim 17, wherein the total steering rod force is determined from the motor current and/or the motor position of one or more electric motors of the electromechanical or electrohydraulic steering system.

21. Method in accordance with claim 12, wherein a sideslip angle is determined from the determined lateral force.

22. Method in accordance with claim 12, wherein a coefficient of friction is determined from the determined lateral force.
